(19) United States
(12) Patent Application Publication
(10) Pub. No.: US 2012/0301863 A1
(43) Pub. Date: Nov. 29, 2012

(54) Interactive Learning Network

(76) Inventors: Kamal Bijlani, Kollam (IN); P. Venkat Rangan, Coimbatore (IN)

(21) Appl. No.: 13/408,060

(22) Filed: Feb. 29, 2012

(30) Foreign Application Priority Data
May 27, 2011 (IN) 1810/CHE/2011

(51) Int. Cl. G09B 7/00

(52) U.S. Cl. 434/362

(57) ABSTRACT

A system for providing network-based interactive learning including at least one network-connected passive server and at least one network-connected active server, each executing software from a non-transitory physical medium. The passive server provides a log-in function providing log-in for a student for a specific learning session, a provisioning function downloading reference materials for the particular learning session to the student's appliance after log-in, and a switch function connecting the student's appliance to the at least one active server after the reference material is downloaded. The active server provides control of the specific learning session by managing communication between a presenter and individual logged-in students, and by transmitting control messages to the student's appliances, the control messages initiated by activity of the presenter, and by causing display of individual portions of the reference materials downloaded to the student's appliances by the at least one passive server after log-in.

### CROSS-REFERENCE TO RELATED DOCUMENTS

The present invention claims priority to a Indian provisional patent application 1810/CHE/2011, filed May 27, 2011, entitled Method to Provide Real Time Collaborative Virtual Interactive E-Learning Environment, disclosure of which is incorporated herein in its entirety by reference.

### BACKGROUND OF THE INVENTION

1. Field of the Invention

The present invention is in the field of network-based interactive learning, and pertains more particularly to methods and apparatus for providing and practicing a network-based learning environment.

2. Discussion of the State of the Art

The education industry is, at the time of this writing, facing a shortage of experienced faculty and training personnel. As a result, online learning systems, also referred to as E-learning systems, exist for teaching or lecturing students. Such systems are being further developed to offer crucial solutions to traditional teaching methodologies. One key aspect of an E-learning is an ability to provide education through virtual learning environments whereby particular courses are taught to multiple students through an online system. Using these E-learning systems, professors can conduct classes, lectures, testing, and so on from their own respective locations, the audience accessing the system from their respective remote locations.

Many video conferencing systems operate in a mode where all the participants can see one another. However in this mode of operation, adaptive bandwidth techniques are utilized. In adaptive bandwidth techniques, the bandwidth required on the server side increases exponentially and the bandwidth required at the client side increases linearly with the number of users logged onto the system. Therefore there is a limit to the number of students that can interact with the system without delay and latency issues caused by insufficient bandwidth.

What is clearly needed are methods and apparatus for providing network-based interactive learning that are more interactive and use minimum bandwidth, thereby reducing latency and delay and raising the quality of the interaction.

### SUMMARY OF THE INVENTION

The problem stated above is that more bandwidth for online interaction is desirable for an Internet-based learning system, but many of the conventional means for reserving shared bandwidth for interaction, such as traditional server/client architectures, also exhibit network latency. The inventors therefore considered functional components of a network-based learning system, looking for elements that exhibit seamless interoperability that could potentially be harnessed to provide bandwidth use reduction in multiple-student access scenarios but in a manner that would not create latency.

Every online learning system is characterized by the number of students that actively utilize the server-based system, one by-product of which is a limitation on the number of students that may participate efficiently in a learning event simultaneously due to bandwidth restrictions. Most such systems employ servers and software to communicate active collaborative updates from student interaction to all of the connected student nodes, and servers and software are typically a part of such apparatus.

The present inventor realized in an inventive moment that if, during a learning event, server-side bandwidth increased only linearly as opposed to exponentially, significant improvement in bandwidth reservation would result. The inventor therefore constructed a unique network-based interactive learning system and method for multi-user online learning that allowed content to be distributed effectively among a larger number of users, but bandwidth allocation for currently interactive as opposed to currently passive users logged into the system. A significant reduction in bandwidth requirement results, with no impediment to efficiency created.

Accordingly, in one embodiment of the present invention, a system for providing network-based interactive learning is provided, comprising at least one network-connected passive server, at least one network-connected active server, software executing on each of the passive and active servers from a non-transitory physical medium. The software executing on the at least one passive server provides a log-in function providing log-in for a student for a specific learning session, a provisioning function downloading reference materials for the particular learning session to the student's appliance after log-in, and a switch function connecting the student's appliance to the at least one active server after the reference material is downloaded. The software executing on the at least one network-connected active server provides control of the specific learning session by managing communication between a presenter and individual logged-in students, and by transmitting control messages to the student's appliances, the control messages initiated by activity of the presenter, and causing display of individual portions of the reference materials downloaded to the student's appliances by the at least one passive server after log-in.

In one embodiment there is further an interactive interface on a student's appliance connected to the at least one network-connected active server, the interactive interface enabled to display the individual portions of the reference materials and to provide communication services between the student and the presenter, including at least voice and video communication. Also in one embodiment the interactive interface additionally provides one or more interactive buttons or menu items for sending commands and/or requests to the active server and/or the presenter.

In one embodiment the software executing on the at least one active server further monitors and records changes in reference materials, and periodically updates the at least one network-connected passive server with said changes. Also in some embodiments the interactive interface further comprises a digital whiteboard responding to input from the presenter. Commands or requests may include initiating entering of entering authentication credentials, submitting a query, requesting a chat, or opening a voice channel.

In some embodiments the interactive interface displays multiple active windows simultaneously, and in some embodiments the interactive interface displays a single active window and multiple tabbed windows interchangeable for display upon tab activation.

In another aspect of the invention a method providing network-based interactive learning is provided, comprising the steps of (a) logging in a student for a specific learning session through the student's connected appliance at a network-connected passive server; (b) downloading reference materials for the particular learning session to the student's appliance after log-in by the network-connected passive server; (c) switching the student's appliance to a network-connected active server after log in; and (d) providing control of the specific learning session through the network-connected active server by managing communication between a presenter and the student, and by transmitting control messages to the student's appliance, the control messages initiated by activity of the presenter, and causing display of individual portions of the reference materials downloaded to the student's appliance by the at least one passive server after log-in.

In one embodiment of the method the invention further comprises displaying the portions of the reference materials on an interactive interface on the student's appliance connected to the at least one network-connected active server, the interactive interface enabled to display the individual portions of the reference materials and to provide communication services between the student and the presenter, including at least voice and video communication.

Also in one embodiment the method involves sending commands and/or requests to the presenter or the network-connected active server by manipulation by the student of one or more interactive buttons or menu items in the interactive interface. In another embodiment the method comprises monitoring and recording changes in reference materials, and updating the at least one network-connected passive server with said changes periodically.

In some embodiments of the method includes displaying and managing a digital whiteboard responding to input from the presenter. Commands and requests may include entering authentication credentials, submitting a query, requesting a chat, or opening a voice channel. In some cases the interactive interface displays multiple active windows simultaneously, and in other cases windows are managed in tab context wherein the interactive interface displays a single active window and multiple tabbed windows interchangeable for display upon tab activation.

### BRIEF DESCRIPTION OF THE DRAWING FIGURES

FIG. 1 is an architectural view of a communications network supporting an interactive learning system according to an embodiment of the present invention.

FIG. 2 is a block diagram illustrating a distributed content delivery network for reducing bandwidth according to the embodiment of FIG. 1.

FIG. 3 is an exemplary snapshot view of a student interface to the interactive learning system of FIG. 1.

FIG. 4 is an exemplary snapshot view of the student interface of FIG. 3 in an alternate mode.

FIG. 5 is a process flow chart illustrating steps for treating student participation in the interactive learning system of FIG. 1.

FIG. 6 is a process flow chart illustrating steps for following a document presentation according to the embodiment of FIG. 1.

### DETAILED DESCRIPTION

The present inventors provide a unique interactive learning system that allows for more interactive opportunities, less bandwidth consumption, and greater student participation than available conventionally at the time of this application. The present invention is described in enabling detail using the following examples, which may describe more than one relevant embodiment falling within the scope of the present invention.

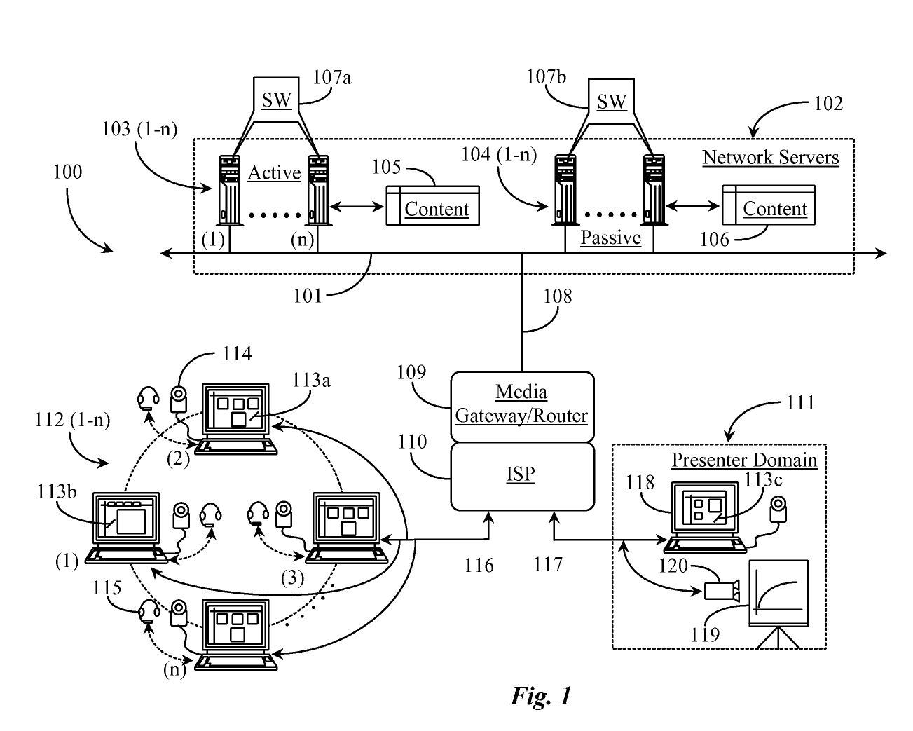

FIG. 1 is an architectural view of a communications network 100 supporting an interactive learning system according to an embodiment of the present invention. Communications network 100 includes a digital network segment represented herein logically by a network backbone 101. Network segment 101 may be a corporate or campus local-area-network (LAN) connected to a wide-area-network (WAN) such as the Internet network. Network 101 may be a corporate or campus WAN or a series of connected LANs forming a campus network. Network segment 101 is in a preferred embodiment accessible through the Internet via any suitably connected sub-network or private carrier network supporting Internet-access services for stationary and mobile appliances. Access to network segment 101 may be made wirelessly or from a wired or switched carrier network like the public switched telephony network (PSTN).

In a preferred embodiment, network segment 101 is analogous to an Internet segment or a digital network segment having 24/7 connection status with the Internet or other WAN as previously described above. In this embodiment, backbone 101 logically represents all of the lines, equipment, and access points that make up the Internet network as a whole. Therefore, there are no geographic limitations to the practice of the present invention.

Network segment 101 supports a network-based Interactive learning system including content management and delivery architecture of servers, labeled herein network servers 102. In one embodiment, a learning institution such as a university or college hosts network servers 102. In another embodiment, a third-party service entity might host servers 102. Network servers 102 may hereinafter in this specification be referred to as simply as service domain 102 or domain 102.

Domain 102 includes a plurality of active content servers 103 (1-n). Active servers 103 (1-n) include non-transitory physical mediums containing thereon all of the data and software required to enable active service of full multimedia content and associated data and metadata. Active servers 103 (1-n) also have access to a content repository 105, which is adapted to contain all of the content and data subject to service in client/server network architecture.

Domain 102 additionally comprises a plurality of passive content servers 104 (1-n), which also include non-transitory physical mediums containing thereon all of the data and software required to enable passive service of full multimedia content and associated data and metadata. Passive servers 104 (1-n) have access to a content repository 106, adapted to contain all of the content and data subject to service in client/server network architecture. In one embodiment, active servers 103 (1-n), and passive servers 104 (1-n) are characteristic of Architecture for Collaborative Environment (ACE), known to and available to the inventors.

Domain 102 is accessible to external digital networks, which may include a wide variety of communications carrier networks, via an access path 108. A presenter domain 111 is illustrated in this example, and represents a live local area such as a classroom, auditorium, laboratory, or any other location having suitable equipment and network connectivity to record and upload content to network domain 102. A good example of a presenter domain might be that of a lecturer in a university hall giving a presentation. In this example, presenter domain includes a network-connected appliance 118. A presenter may be characterized as any primary live subject that might present materials for consumption and/or dissemination by one or more remote secondary live subjects accessing, receiving, or exchanging the materials over the network.

Appliance 118 may be a laptop or a notebook computer, a personal computer (PC), or an iPad type appliance, among other sorts of appliances. Appliance 118 is network enabled and is telephony enabled via appropriate software applications (not illustrated). Appliance 118 supports full televideo conferencing and may include several software presence and collaboration tools or applications as well. In this example, appliance 118 includes a peripheral camera enhanced for video recording and streaming. Other communications equipment may also be present in presenter domain 111, such as a switched or computer-connected telephone and/or a wireless or wired headset for practicing Internet protocol network telephony (IPNT).

Presenter domain 111 also includes a projector/recorder system 120 enabled for projecting content onto a whiteboard or screen such as screen 119, and for recording and uploading content, such as from an animated presentation projected on to a wide screen. Other equipment or accessories also referred to herein as props might include physical signs, chalk boards, physical live audiences, filmed laboratory experiments, and many other types of static or animated displays. Appliance 118 and, in this case, projector/recorder 120 have connection to network segment 101 through a network-access line 117, an Internet service provider (ISP) 110, a Media Gateway/Router 109, and access path 108. In this interactive learning environment, the presenter may, in one embodiment, engage in a pre-recorded session that is later uploaded or, in a live session that is streamed in real time and may be interactive.

A plurality of student appliances 112 (1-n) are illustrated in this example. Student appliances 112 (1-n) have network-access capability and in most cases full multimedia and telephony capabilities, including live voice and video conferencing in the same fashion described above relative to appliance 118. In this example live camera 114 provides a live student picture feed and headset 115 provides bi-directional audio including voice feed. Appliances 112 (1-n) are laptop computers in this example however, other types of network-capable and telephony-capable appliances may be used, including iPad-type appliances, notebooks, smart phones, and android devices. Stationary PCs may also be used by students to participate in the system of the invention. In this example, student appliances 112 (1-n) have connection to network backbone 101 through a network access line 116, ISP 110, Multimedia Gateway 109, and access path 108.

Student appliances 112 (1-n) include student interface applications 113 (a, b). More particularly, appliances 112 (2-n) are running version (a) of interface 113 and appliance 112 (1) is running version (b) of interface 113. The difference in the application versions is the mode in which the interface is displayed on the appliance. For example, version 113a includes a plurality of open display windows, each window providing a component of a learning session. Version 113b is set to “tabs mode” where one active display window is visible while the other available display windows are tabbed. In tabs mode only a currently active window is displayed. Student interfaces 113 (a, b) may be set in the mode for single active window display with the other display windows tabbed in the interface, or in the mode that displays all of the windows simultaneously.

In one embodiment interface 113 is a browser-nested plug-in that might be downloaded permanently or that might be served via active servers 103 (1-n) or via passive servers 104 (1-n). Also in one embodiment student interface applications run on the servers and plug-in to resident browser applications. In another embodiment, the student interface applications are standalone programs executing from the student appliances.

Presenter appliance 118 includes a presenter interface application 113 (c). Like interfaces 113 (a, b), interface 113 (c) may be a standalone program, a browser plug-in, or a server-based interface. More detail about the student and presenter interfaces and capabilities is provided below in this specification. All of the interfaces allow interactivity between the presenter and the students, brokered by the active and passive servers in network domain 102.

In one embodiment general use of the invention is characterized by the presenter using appliance 118 aided by SW 113 (c) to capture and upload live, demonstrative, and interactive content to active servers 103 (1-n) for active service to students operating appliances 112 (1-n) aided by SW 113 (a, b). Active servers 103 (1-n) and passive servers 104 (1-n) include software 107a (active servers) and 107b (passive servers) adapted to broker the interactive content between the presenter operating appliance 118 and the students operating appliances 112 (1-n). In one embodiment students operating appliances 112 (1-n) log in to participate in an interactive learning session via passive servers 104 (1-n). At login, the students receive current content and state information before being re-directed to the active servers for interaction and general session participation. In this example, the active servers continually update the passive servers used for updating student appliances.

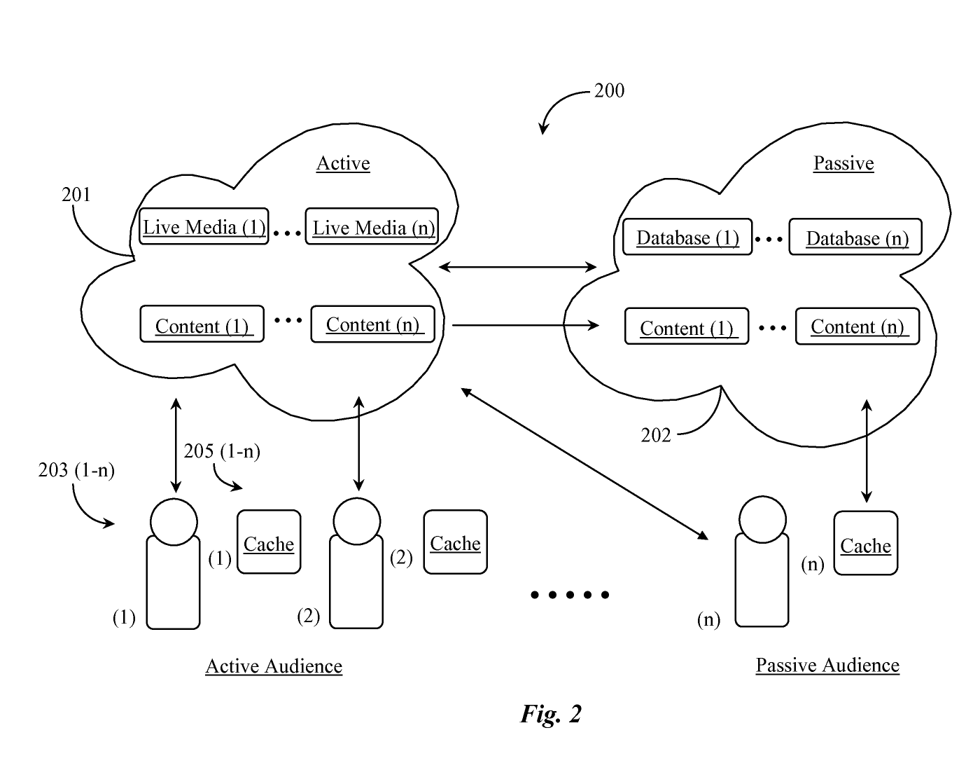

FIG. 2 is a block diagram illustrating a distributed content delivery network 200 for reducing bandwidth according to the embodiment of FIG. 1. Network 200 includes an active server cluster 201 analogous to active servers 103 (1-n) of FIG. 1. Active server cluster 201 includes live media servers (1-n) and content servers (1-n). Network 200 also includes a passive server cluster 202 analogous to passive servers 104 (1-n) in FIG. 1. Passive server cluster 202 includes database servers (1-n) and content servers (1-n).

According to one embodiment of the invention, server clusters 201 and 202 are implemented with a scalable and distributive Architecture for Collaborative Environment (ACE). Such a distributed architecture enables a live interactive classroom environment that can be served to a larger number of students. ACE implementation is centered on a distributed client-server architecture where participants communicate with one another using control messages. The active and passive clusters communicate with one another. Active cluster 201 continuously updates passive cluster 202 with the active, collaborative object information that is being constantly changed by interaction of the various users (students, teachers).

In various embodiments of this invention a collaborative object is characterized as an object-oriented file wrapper with a set of messages and associated actions. An audience 203 (1-n) includes those students that are active 203 (1, 2) and one that is passive, or still in the process of log-on to participate. Each student in audience 203 (1-n) has a local memory cache of local memory caches 205 (1-n) on the appliance used to engage and participate in the interactive learning system. Student 203 (n) having local memory cache 205 (n) running on the accessing appliance (appliance not illustrated) logs into the interactive learning system through passive server cluster 202. Cache 205 (n) is updated relative to multimedia content and state information by database and content servers in passive server cluster 202 during initialization. After cache 205 (n) is updated with the latest content and state data, student 203 (n) may be re-directed to active server cluster 201 for active session collaboration.

According to a preferred embodiment of the present invention, active server cluster 201 continuously updates the passive server cluster 202 with all events related to collaborative objects, such as animation objects, active documents, and whiteboard content. The active cluster records all the collaborative object events in the content server. The recorded events are used to incrementally update the database and content servers of the passive cluster. When a new user logs in, the content on the local appliance of that user is updated and timestamped from the passive cluster for faster access during collaboration.

According to an embodiment of the present invention, the user gets switched from the passive server to the active server after successful initialization of all the required multimedia content and state information as described above. Further, the cached information has a timestamp associated with it to prevent any loss of state information since new events may have occurred at the active server during the transaction of logging the new user into the system and redirecting the user to the active cluster. After a successful completion of a transaction of the user from the passive server to the active server, the user's timestamp is compared with the recorded timestamps in the active server and for any new events that have occurred during the transaction the user content will be updated and synchronized to the latest information.

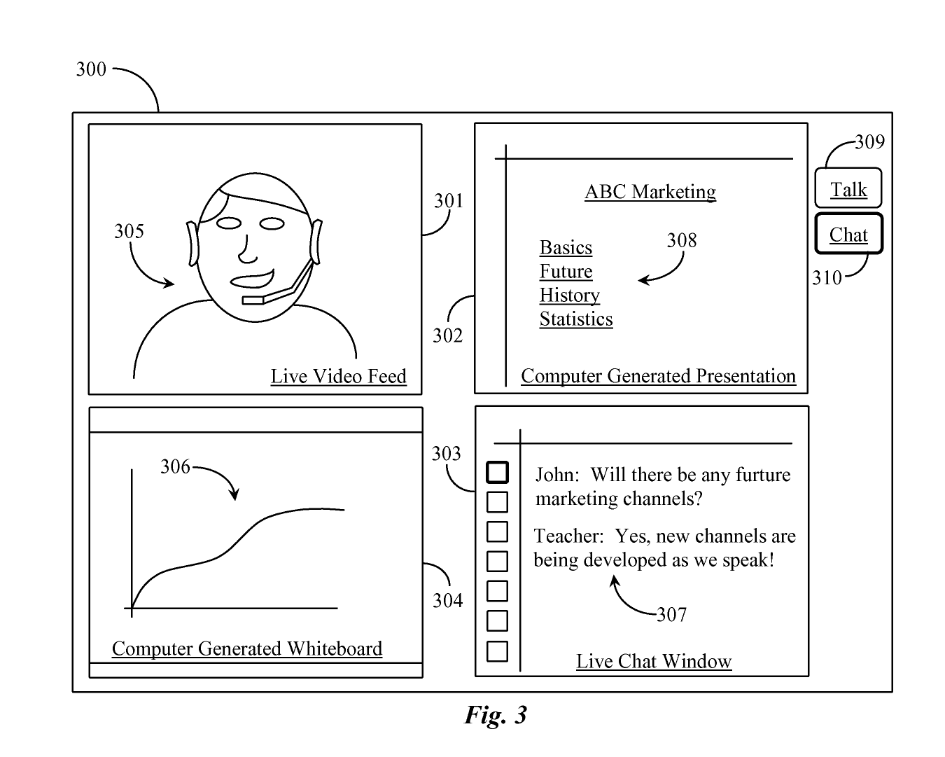

FIG. 3 is an exemplary illustration 300 of an interactive student interface 113 (a, b) of the interactive learning system of FIG. 1. Illustration 300 depicts the student interface of FIG. 1 in a mode that simultaneously displays multiple windows. For example, a display window 301 presents the live audio and video of a primary live subject 305, such as a teacher, lecturer, or presenter. Window 301 in this example is a live feed. In other embodiments window 301 may contain pre-recorded audio/video clips. Illustration 300 includes a display window 302 that contains a single or multi-page computer-generated presentation 308 that the primary live subject is presenting to a virtual class. Presentation 308 may be a PowerPoint presentation or some other type of presentation, such as a multi-page PDF. For sharing documents such as a PowerPoint presentation or a PDF, the teacher copies the file into a common location. When the students log in the file is copied to their local machine cache memory. During the active session, only the page number or the relative position of the document need be transferred from the teacher node to all the student nodes. By using a file caching mechanism that responds to relative location information such as a transmitted page number or document position, the bandwidth required is minimized after the initial transfer.

Illustration 300 includes a live chat window 303. Chat window 303 may be invoked by a secondary live subject such as a student wishing to chat one-on-one with, for example, a primary live subject like the teacher. A chat button 310 is provided in the interface for launching the chat window. In one embodiment, there are multiple students depicted as icons in a sidebar area of the window. The bolded icon 310 logically represents a student (John) engaged in a chat sequence 307 with a teacher. In this embodiment, all of the other students may see the chat transcript and the presence information confirming that John and the teacher are live chatting. However, none of the other students are expending bandwidth unless they are active in the current chat session. In one embodiment, a student may request a side chat session that may not be visible to the other students.

In one embodiment, illustration 300 includes a push-to-talk button 309. Talk button 309 causes a walkie-talkie-like session enabling bi-directional voice interaction between a secondary live subject like a student and a primary live subject such as a teacher. Other communications request channels may be added to this example without departing from the spirit and scope of the present invention. Bi-directional camera enhancement enables the interactive learning system to detect if a student has, for example, indicated to ask a question of the teacher. Detecting such an overture at system level causes a control message to be propagated to the appliance used by the teacher and informs the teacher via a visual, audio, or audio/visual notification that a student has indicated a desire to ask a question. Any manner of automated visual detection capability at the server-side might be employed to detect when a student has indicated a desire to communicate by asking a question or supplying an answer to a question posed by the teacher. Moreover, the teacher may be enabled visually to manually detect such an event provided that all of the student interface video feeds are currently visible to the teacher.

Illustration 300 additionally includes a display window 304 in one embodiment that depicts a computer-generated whiteboard with a current graphic 306 displayed. Windows 301-304 in this instance are all displayed simultaneously, although the teacher may be actively addressing or manipulating a single prop such as the whiteboard, for example, for student view and interaction. As the teacher switches from one prop to another in an active learning session, the physical characteristics of the window display depicting the live feed of the prop may change so that the students are instantly aware of which windows are currently active or not active. In one embodiment, where there are tabbed windows where one is displayed, when the teacher selects another prop, the window for that prop may automatically display and the last window that was active gets tabbed with the other inactive windows.

In one embodiment, a primary subject like a teacher, lecturer, or a presenter may have a sensor device worn on the finger or hand, and that device may be used to electronically “select” a prop for display in the interface by a wave or the hand or a point of the finger, similar to a wireless sensing unit used with some Weii™ system games. This example represents a basic functional interface that may toggle between multiple display windows and may include additional communications features like push-to-talk and live chat. There may be added communication channels and other presence-based live capabilities included in various embodiments without departing from the spirit and scope of the invention. For example, additional features may include but are not limited to a real-time document sharing function, a desktop sharing function, a recording and playback function, and a hand-raise function for posing a question.

In a preferred embodiment of the present invention the system allots bandwidth only when required. Therefore at the student end the bandwidth required for interaction defined as between a student and the teacher is limited to the teacher bandwidth and the single student bandwidth. Bandwidth required at the server increases linearly as opposed to exponentially in line with the number of students logged into the system. Only the minimum bandwidth is required at the student appliance as local cache serves up all of the supporting static content downloaded at time of log-in of the student. Therefore a large number of students may be present in the interactive learning environment without causing undesired latency or delay. Also in a preferred embodiment, software on the servers (107 a, b) determines which of the active and passive servers to connect students to based on network locations of the students in order to help further reduce bandwidth requirements.

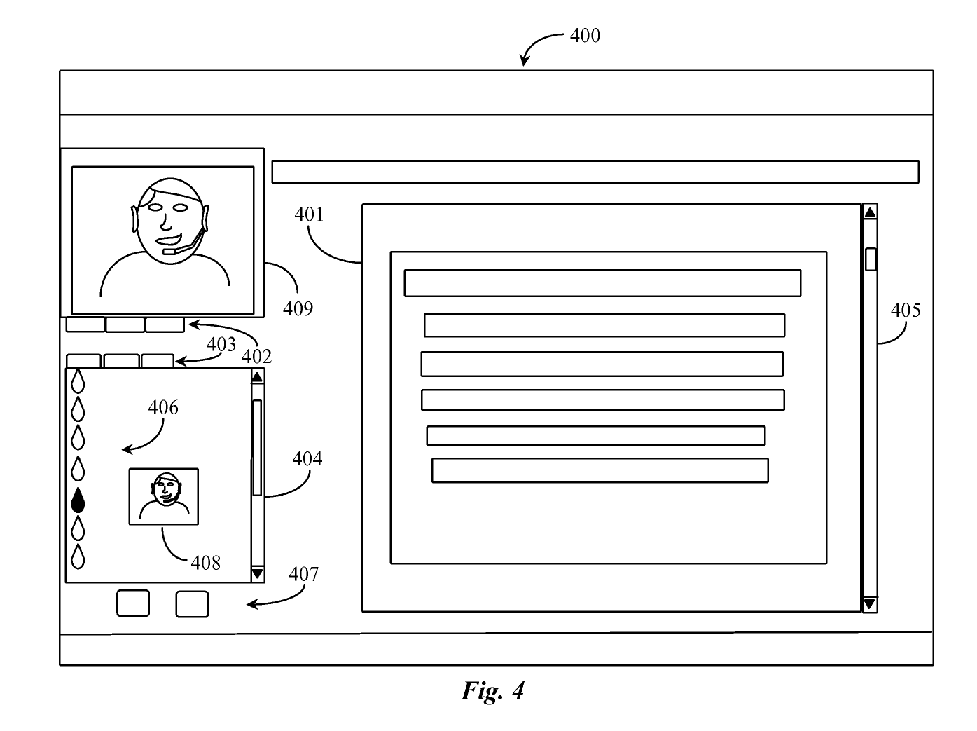

FIG. 4 is an exemplary illustration 400 of the student interface of FIG. 3 in an alternative mode. Illustration 400 depicts the student interface in another programmable mode such as was described further above wherein windows are tabbed and only the active window is displayed. In this example, a display window 401 is currently active. Display window 401 contains a multiple page presentation. As the teacher selects pages or scrolls through the presentation instruction data is transmitted to the student's appliance, which pages the student's view using the locally-stored copy of the document. In one embodiment, the scroll bar 405 is also visible to the students and may be manipulated to preview something that had already transpired without interrupting the current presentation, and that scroll operates also on the locally-stored content. A capture and playback function may be used to enable this feature.

In this example a display window 409 (reduced in size) depicts the live video and audio feed of the primary live subject (teacher), which may be always visible in the student interface. Several tabs 402 indicate further display windows tabbed rather than expanded for display. In this example, a query window 404 is illustrated that reports the virtual presence of all of the connected and participating students 406 (teardrops). Buttons 407 may include an interactive hand-raise button and a permission-notification graphic that may light up if the teacher accepts a request to talk. In this case a student 406 (blacked) has activated the hand-raise button 407 and the teacher has selected the student to ask a question. In one embodiment, a live audio-visual feed 408 (thumbnail view) of the student asking the question is visible to all the other students and the teacher. Tabs 403 may represent alternate views of window 404, or additional tabbed windows that might be used by the teacher to display more content to students.

In one embodiment, the tabbed displays are automatically activated when the teacher selects the associated active content for display. The displayed content also is paginated or scrolled automatically in the active display window on the student appliance as the teacher turns pages or scrolls content. In one embodiment, regardless whether the interface is set to tabbed mode or multiple windows mode at student interfaces, the teacher may cause more than one active window to run and display concurrently in the interface such as a whiteboard display and a chat window.

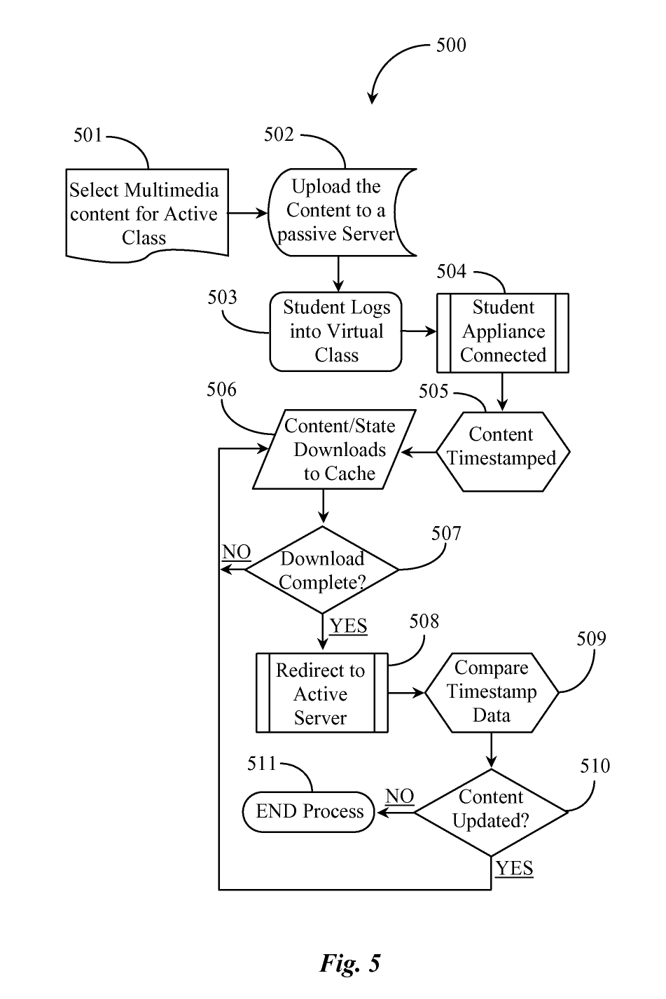

FIG. 5 is a process flow chart 500 illustrating steps for treating student participation in the interactive learning system of FIG. 1. At step 501, a primary live subject such as a teacher, lecturer, or presenter selects and prepares multimedia content for a scheduled active virtual class or session. In this embodiment the virtual class is conducted live. At step 502, the teacher uploads any static content to a common location such as a passive server for eventual pre-caching on student appliances at the time of initialization.

At step 503, a student logs into the virtual class. There may be many students performing this operation simultaneously connecting to one or more passive servers to complete the transaction. In one embodiment, students are paired with servers based on network location to reduce latency. In this case, the shortest network paths between student appliances and the selected servers are prioritized.

At step 504, the student's appliance is connected to a passive server. At this point, multi-media content for download the student's appliance is timestamped at step 505. The content is timestamped to make sure that any updates to the content resulting from class interaction that occur during initialization may be identified and passed to the student after redirection of the student to an active server. At step 506, the content and current state information is downloaded to cache memory on the student's appliance. A caching mechanism linked to the student's interface as a plug-in may be provided for associating the cached content to the virtual class session about to occur.

At step 507, it is determined at the server-side if the content download of step 506 is complete. If it is not complete the process resolves back to step 507 until the download is complete. If it is determined at step 507 that the content download is complete, the passive server redirects the connected student appliance to an active server at step 508. During this transaction, the shortest available network path between the student's appliance and a potential active server is utilized. Moreover, current server load is also considered in the selection of a server that may best fit a student appliance connection.

At step 509, the active server collects the timestamp associated with the content and state information downloaded to the student cache at step 506. The server compares the current timestamp of the active server content and state information currently in the content server of the active server with the collected timestamp. At step 510, the active server determines if the content and or state information requires update due to any changes to the content or state information that may have occurred during student appliance initialization and redirection from the passive server to the active server. If the active server determines that there were updates since the last time reflected in the collected timestamp data, the process may end at step 511. However, if the content in the active server reflects one or more updates to content or state information at step 510, the process resolves back to step 506 whereby the updated content/state information is downloaded to cache on the student's appliance.

In one embodiment, the active server performs the download of any updated content or state information that the student missed during the login and server redirection process. In one embodiment, the passive server connection is not dropped immediately during redirection and the passive server pushes the updated content to the student appliance cache memory immediately after receiving the update from the active server cluster. In one embodiment, the passive server connection is activated any time the student requires content or state information updating during the active session reserving the active server bandwidth for class interactivity dissemination and distribution to all the other connected student appliances.

In this embodiment, when the teacher selects a PowerPoint presentation, for example, the presentation in “cache” on the student machine immediately displays from cache in an active display window. When the teacher changes slides, control messages are passed to the student interface and the presentation in the display running from the student's cache memory changes position accordingly. In one embodiment, if the presenter or teacher-occupied live location is a large classroom or a seminar hall, projectors can be used instead of LCD monitors to improve visibility. The students can see the teacher video, document, and whiteboard. A single display system can still be projected on a large screen in a large seminar hall to enable everyone in the class to see the system.

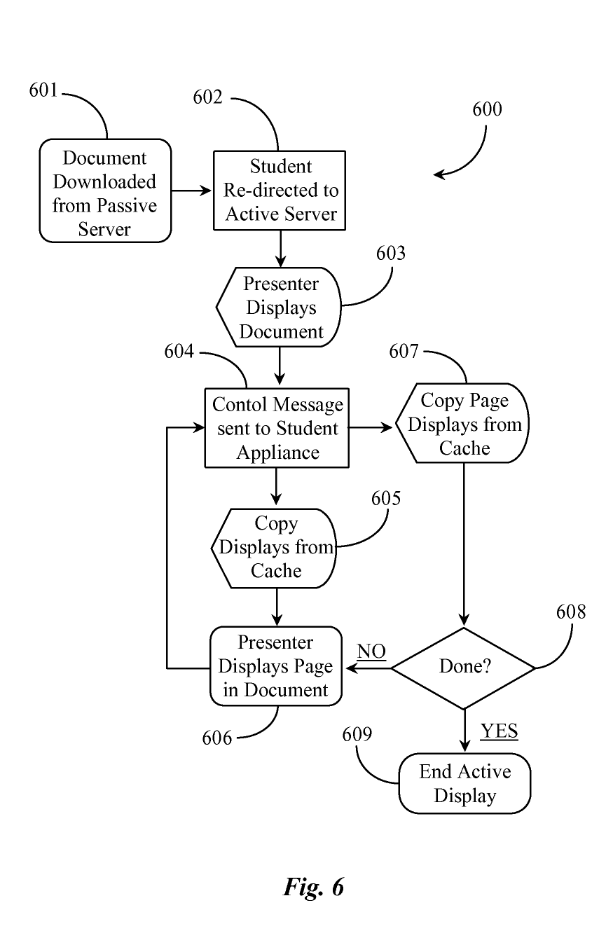

FIG. 6 is a process flow chart 600 illustrating steps for following a document presentation according to the embodiment of FIG. 1. At step 601, a document is downloaded to a student appliance cache system from a passive server. It is assumed in this example that the document is a multi-page document, and that the download occurs during login by the student before the start of the virtual class.

At step 602, the student is redirected to an active server in the same manner as described in FIG. 5 regarding step 508. At step 603, the presenter displays the document during the active virtual class session. At step 604 a control message is severed to the student appliance from the active server. The control message of step 604 includes state information relative to the current action made by the presenter. At step 605, the downloaded copy of the document loaded on the student appliance displays from the student's cache.

At step 606, the presenter displays a document position or page in the document. The process then resolves back to step 604 whereby a control message containing state information relative to the latest position in the document is sent to the student appliance. At step 607, the appropriate position or document page automatically displays from cache according to the received state information in the control message.

At step 608, the presenter (active server) determines if the current document interaction is done. If the document display is finished at the active server, then the active display of the document on the student machine may end. For example, the presenter may switch content, pointing to a different document or whiteboard, for example. If the presenter is not finished manipulating the active document at step 608, then the process resolves back to step 606 then step 604, then step 607. In this way, bandwidth is checked linearly at the active server side. The presenter may switch to any prop for active display and the corresponding portion or position of the active document or presentation displays on the student appliances immediately after the associated control message is received from the active servers.

In one embodiment, the virtual learning system further comprises a knowledge library. A knowledge library may be provided for students to remotely access all of the recorded and archived classroom sessions. Such session may be held and maintained in a central repository indexed by the teacher name, topic name, institute name, date, and time. All the live lectures are recorded and are made available to the students. In one embodiment, a 24-hour chartroom characterizing a knowledge café may also be provided and maintained separately from a teacher/student chat feature active when a student makes a request to chat with the teacher.

It will be apparent to one with skill in the art that the interactive virtual learning system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

What is claimed is:

1. A system for providing network-based interactive learning comprising:
at least one network-connected passive server;
at least one network-connected active server;
software executing on each of the passive and active servers from a non-transitory physical medium, the software executing on the at least one passive server providing:
a log-in function providing log-in for a student for a specific learning session;
a provisioning function downloading reference materials for the particular learning session to the student's appliance after log-in; and
a switch function connecting the student's appliance to the at least one active server after the reference material is downloaded;
the software executing on the at least one network-connected active server providing control of the specific learning session by managing communication between a presenter and individual logged-in students, and by transmitting control messages to the student's appliances, the control messages initiated by activity of the presenter, and causing display of individual portions of the reference materials downloaded to the student's appliances by the at least one passive server after log-in.

2. The system of claim one further comprising an interactive interface on a student's appliance connected to the at least one network-connected active server, the interactive interface enabled to display the individual portions of the reference materials and to provide communication services between the student and the presenter, including at least voice and video communication.

3. The system of claim 2 wherein the interactive interface additionally provides one or more interactive buttons or menu items for sending commands and/or requests to the active server and/or the presenter.

4. The system of claim 1 wherein the software executing on the at least one active server further monitors and records changes in reference materials, and periodically updates the at least one network-connected passive server with said changes.

5. The system of claim 2, wherein the interactive interface further comprises a digital whiteboard responding to input from the presenter.

6. The system of claim 3 wherein the commands or requests include initiating entering of entering authentication credentials, submitting a query, requesting a chat, or opening a voice channel.

7. The system of claim 2 wherein the interactive interface displays multiple active windows simultaneously.

8. The system of claim 2 wherein the interactive interface displays a single active window and multiple tabbed windows interchangeable for display upon tab activation.

9. A method providing network-based interactive learning comprising the steps of:
(a) logging in a student for a specific learning session through the student's connected appliance at a network-connected passive server;
(b) downloading reference materials for the particular learning session to the student's appliance after log-in by the network-connected passive server;
(c) switching the student's appliance to a network-connected active server after log in; and
(d) providing control of the specific learning session through the network-connected active server by managing communication between a presenter and the student, and by transmitting control messages to the student's appliance, the control messages initiated by activity of the presenter, and causing display of individual portions of the reference materials downloaded to the student's appliance by the at least one passive server after log-in.

10. The method of claim 9 further comprising displaying the portions of the reference materials on an interactive interface on the student's appliance connected to the at least one network-connected active server, the interactive interface enabled to display the individual portions of the reference materials and to provide communication services between the student and the presenter, including at least voice and video communication.

11. The method of claim 10 comprising sending commands and/or requests to the presenter or the network-connected active server by manipulation by the student of one or more interactive buttons or menu items in the interactive interface.

12. The method of claim 9 further comprising monitoring and recording changes reference materials, and updating the at least one network-connected passive server with said changes periodically.

13. The method of claim 10 further comprising displaying and managing a digital whiteboard responding to input from the presenter.

14. The method of claim 11 wherein the commands or requests include entering of authentication credentials, submitting a query, requesting a chat, or opening a voice channel.

15. The method of claim 10 comprising displaying in the interactive interface multiple active windows simultaneously.

16. The method of claim 10 comprising managing windows in tab context wherein the interactive interface displays a single active window and multiple tabbed windows interchangeable for display upon tab activation.
